(19) United States
(12) Patent Application Publication
(10) Pub. No.: US 2026/0020555 A1
(43) Pub. Date: Jan. 22, 2026

(54) System and Method for a Fence Trimmer

(71) Applicant: Neal R. Winberg, Westcliffe, CO (US)

(72) Inventor: Neal R. Winberg, Westcliffe, CO (US)

(21) Appl. No.: 19/208,694

(22) Filed: May 15, 2025

Related U.S. Application Data
(60) Provisional application No. 63/649,521, filed on May 20, 2024.

(51) Int. Cl. A01M 21/02

(52) U.S. Cl. CPC A01M 21/02

(57) ABSTRACT

A system and method for trimming. The system includes a quick detach for coupling to a host vehicle. There is a control arm coupled to said quick detach. There is a a vertical support coupled to said control arm. The vertical support extends between a top frame and a lower frame. There is a first assembly extending between said top frame and said lower frame, and a second assembly extending between said motor frame and said lower frame. The first and second assembly each comprises at least one cutting member. The cutting member, when rotated, cuts debris such as weeds and tumbleweeds.

### TECHNICAL FIELD

The present invention claims priority to U.S. Provisional Application No. 63/649,521 filed May 20, 2024, the entirety of which is hereby incorporated by reference.

### BACKGROUND OF THE INVENTION

### Technical Field

The present invention relates to a system and method for a fence, or other structure, trimmer.

### Description of Related Art

Weed trimmers are used to trim weeds and other items. However, existing weed trimmers are insufficient when it comes to many fences and other structures. Further, weed trimmers are insufficient against larger weeds. Consequently, there is a need for an improved trimmer which can be used on fences.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a fence in one embodiment;

FIG. 2 is a perspective view of the trimmer system in one embodiment;

FIG. 3 is a top perspective view of the trimmer system in an extended position in one embodiment;

FIG. 4 is a top perspective view of the trimmer system in a retracted position in one embodiment;

FIG. 5 is a top perspective view of the trimmer system in a rotated position in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

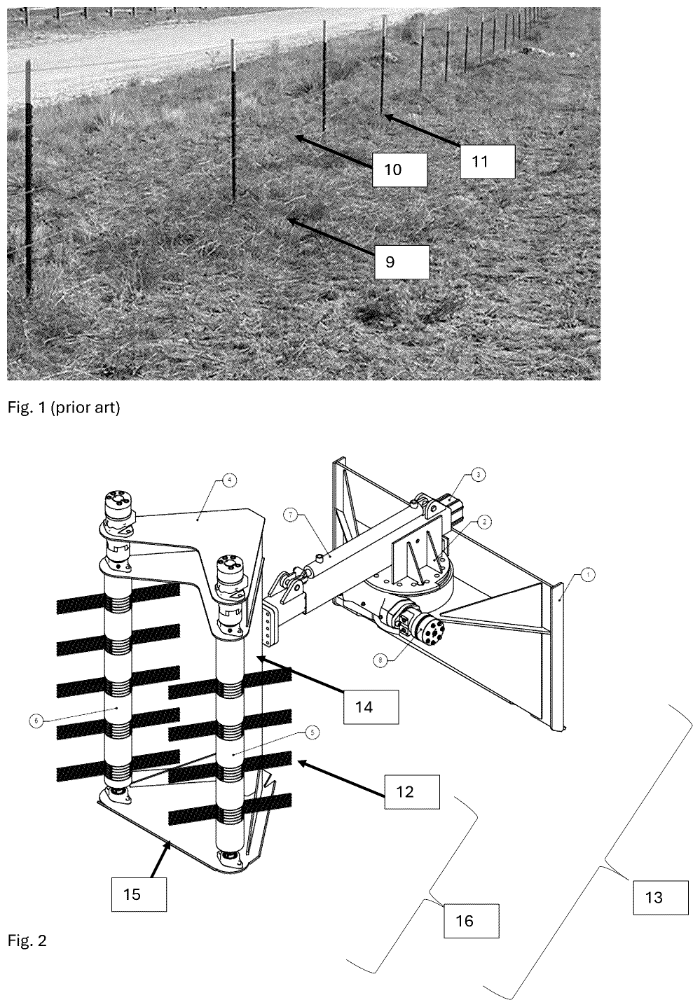

Turning to FIG. 1, FIG. 1 is a perspective view of a fence in one embodiment. The system and method can be used on or near virtually any type of fence. Further, while the system and method can be used on a fence with rails, as discussed herein, the system and method can be used with virtually any fence. Further, the system has a plurality of cutting members, in one embodiment. Thus, it can be used to cut or trim virtually any weed, brush, etc., whether by a fence or not.

The fence 9 depicted in FIG. 1 is a barbwire fence. This particular fence has a plurality of spaced-apart vertical posts 11. The fence 9 also has a plurality of spaced-apart horizontal fence rails 10. As shown, each fence rail 10 comprises wire or barbwire. This is for illustrative purposes only and should not be deemed limiting.

Brush, weeds, and other plants can grow and collect around the posts 11 and rails 10. Additionally, weeds which grew elsewhere but then collected adjacent to the fence 9, such as tumbleweeds, can collect along the fence 9 for extended periods of time. They often become stuck or lodged within the fence 9. This is undesirable for a variety of reasons. First, it is often unsightly. Second, a lodged tumbleweed will cause other tumbleweeds and other items to likewise become stuck or lodged. Third, any combustible material, such as tumbleweeds create a fire hazard. A tossed cigarette or other spark can ignite the dry tumbleweeds. Given the danger of wildfires, and the amount of land, property, and lives which can be taken, prevention of additional fires is warranted. Removing such combustibles results in increased safety. As such, the tumbleweeds, and other weeds, plants etc., should be removed. As noted, prior art weed trimmers are insufficient to cut or properly remove some tumbleweeds. A prior art weed trimmer typically has a single string, so cutting tumbleweeds which are often several feet high and several feet in diameter is difficult. Further, fence lines are often miles long, so attacking this problem with a hand held weed trimmer is not sufficient.

It should be noted that while reference is often made to a fence 9, this is for illustrative purposes only and should not be deemed limiting. The trimming system can clean and remove brush and debris from various locations. It can clean brush alongside fences, ditches, tree rows, along barns, etc. Many of these surfaces attract and allow brush to settle and collect. The systems and methods discussed herein provide ways to remove the brush or other debris from these surfaces.

Turning to FIG. 2, FIG. 2 is a perspective view of the trimmer system in one embodiment. One embodiment will be discussed as a system which can be coupled to another vehicle, such as a skid steer, forklift, truck, tractor, or the equivalent which can hold, secure, control, and power the trimmer system 13. In one embodiment, the host vehicle, the vehicle to which the trimmer system 13 is coupled, comprises power and hydraulics to operate and power the trimmer system 13.

The trimmer system 13 can be powered via any method known in the art. The trimmer system 13 can be electric, hydraulic, etc. Any power source which can move and manipulate the various components can be utilized. Additionally, while some embodiments disclose a hydraulic system which can move the connector arm 3, as discussed below, in other embodiments the adjustments are made manually. Thus, for example, rather than the connector arm 3 being hydraulic, the arm is manually moved. A bolt, detent, or setting can lock the connector arm 3 in its desired position. In other embodiments a crank, pulley, etc. can be used rather than hydraulics. Thus, the connector arm 3 is extendable from a retracted to an extended position by any method known in the art, either manually or mechanically.

As shown, the quick detach 1 mounts to the host vehicle via any method or device known in the art. The quick detach 1, as shown, comprises a flat plate with an attaching device for coupling to the host vehicle. The flat plate on the quick detach 1 is for illustrative purposes only and should not be deemed limiting. In one embodiment, the purpose of the quick detach 1 is to attach to a host vehicle (not shown). Any quick detach 1 which couples to a host vehicle can be utilized. As noted, in one embodiment the quick detach 1 comprises one or more connectors to allow for rotation, pivoting, etc. The quick detach 1 can comprise bolts, nuts, straps, etc. to allow the quick detach 1 to couple with the host vehicle.

The quick detach 1 can comprise virtually any material of any size. The size and material of the quick detach 1 will depend upon the host vehicle, the size of the trimming system 13, etc. The quick detach 1 can comprise metals such as steel or Aluminum. The quick detach 1 can also comprise plastic, rubber, other metals, and combinations thereof.

The connector arm 3 allows for lateral extension of the system toward and away from the quick detach 1. In one embodiment a cylinder 7 is used to control the lateral extension of the connector 3. In other embodiments actuators or the like can be used. As noted above, the extension can be accomplished manually or mechanically. Virtually any mechanism which provides for lateral extension and retraction of the connector arm 3 can be utilized.

In one embodiment the connector arm 3, while referred to as a single piece is actually two or more concentric arms which fit within one another to extend or retract. In one embodiment, for example, the connector arm 3 comprises two concentric square tubes. The smaller concentric tube fits within the larger tube. To expand, the smaller concentric tube extends outwardly to increase the total length of the connector arm 3. The same is reversed to shorten the length.

There are various techniques to reduce friction between the concentric tubes to allow for a smoother extension. In one embodiment the telescoping arms can have polymers to reduce the friction. As but one example, a high density polyethylene can be used to facilitate smooth transitions. In one embodiment a guide is inserted that allows concentric tubes to slide beyond one another. This rail can have anti-friction capabilities or properties. This can include ball bearings and the like.

The connector arm 3, as well as the other components of the cutting block 16 can comprise virtually any material. This can include metals such as steel or Aluminum. These components can also comprise plastic, rubber, other metals, and combinations thereof.

The connector arm 3 is coupled to a rotary connector 2. The rotary connector 2 allows the connector arm 3 to pivot about the rotary connector 2. The rotary connector 2 can pivot via any method or device known in the art. In one embodiment, the rotary connector 2 is driven by a slew drive 8. Thus, the arm can move laterally relative to the quick detach 1. Further, the connector arm 3 can rotate and pivot relative to the quick detach 1. The rotary connector 2 can comprise any pivot or hinge which allows a piece to rotate via the rotary connector 2. In one embodiment the rotary connector 2 allows for a rotation of 180 degrees.

As shown, the rotary connector is on an upstream end of the connector arm 3. Upstream and downstream refer to relative locations in the system. An item which is closer to the host vehicle is upstream, whereas further away from the host vehicle is downstream. As shown, the connector arm 3 has an upstream end which is closer to the quick detach 1 and a downstream end which is coupled to the vertical support 14. As shown the connector 2 is downstream of the plate of the quick detach 1.

As shown, the plate of the quick detach 1 is vertically oriented. The connector 2 is perpendicular to the plate of the quick detach 1. The connector arm 3 is also perpendicular to the plate of the quick detach 1, but this angle can change as the connector arm 3 pivots about the connector 2.

The ability to move laterally and rotate allows the operator to control the placement of the cutting assemblies 5, 6. The user can move them in to get closer to the fence, for example, and then move them out to account for the fence posts 11. The ability to move laterally and pivot allows the assemblies 5, 6 to achieve the ideal and optimal placement. This also allows for much faster completion of the job as the unit can move in and out as necessary.

The connector arm 3 couples to a vertical support 14. The vertical support 14 can couple to the connector arm 3 via a plate or such, which utilizes bolts, etc. In one embodiment, and as depicted, the connector arm 3 can be de-coupled from the vertical support 14.

The vertical support 14 offers structure to the cutting assemblies 5, 6. As shown, the vertical support 14 extends between the top frame 4, which can house a motor in some embodiments, and the lower frame 15. The top frame 4 is located atop and the lower frame 15 is located on the bottom, with the cutting assemblies 5, 6 located therebetween. As noted, the vertical support 14 extends between the lower frame 15 and the top frame 4.

As shown, the vertical support 14 is upstream from the downstream cutting assemblies 5, 6. As depicted, the top frame and the lower frame 15 comprise a triangular shape. The two cutting assemblies 5, 6 are on two of the points of the triangle, and the vertical support 14 is on the opposing point. The assembly comprising the top frame 4, the lower frame 15, and the cutting assemblies 5,6 is referred to as the cutting block 16. The cutting block 16, as noted, can be moved upstream or downstream.

In some embodiment, the triangular shape of the cutting block 16 allows for a narrower upstream end and a wider downstream end. The narrower upstream end allows for easier pivoting and manipulation of the cutting block 16. The triangular cross-sectional shape of the cutting block 16 is for illustrative purposes only and should not be deemed limiting. The cutting block 16 can have a square cross-section, a circular or oval cross-section, a rectangular cross-section, etc. Virtually any cross-sectional shape of the cutting block 16 can be utilized.

As discussed, the system has at least one cutting assembly 5,6. As shown, and in one embodiment, the cutting assembly 5,6 is a vertical member which supports at least one cutting member 12. When the cutting assembly 5,6 is rotated, so too is the cutting member 12. In this manner, the cutting member 12 contacts brush, debris, etc. and cuts it into smaller and manageable pieces. The size and length of the cutting member 12 can be modified as necessary depending upon the size of the job, type of debris, etc.

The cutting member 12 can comprise virtually any material used to cut weeds, such as discussed above. The cutting member 12 can comprise vinyl material, commonly referred to as weed eater string. Consumable material, such as weed eating string, must be replaced. In one embodiment, the cutting member 12 comprises a spool of consumable cutting material 12 which is released as needed. There are various release mechanisms which can be utilized to deploy the consumable cutting material 12. These can utilize centrifugal force, for example, to deploy a determined amount of cutting material 12. Or, in other embodiments, the user can manipulate the cutting assembly 5, 6 to deploy additional string.

While one embodiment has been discussed whereby the cutting member 12 comprises a consumable material, this is for illustrative purposes only and should not be deemed limiting. In other embodiments, for example, the cutting member 12 comprises a comparatively tougher material which need not be replaced. This can include, for example, pieces of metal, which when rotated, similarly break down the brush or weeds.

As shown, each cutting assembly 5, 6 comprises at least one cutting material located along the length of each cutting assembly. The length is the dimension between the top frame 4 and the lower frame 15. As shown, the first cutting assembly 5 comprises 5 spaced apart cutting members 12. The second cutting assembly 6 comprises 4 spaced apart cutting members 12. As shown, the cutting members 12 on each cutting assembly 5, 6 are off-set. As can be seen, the distance from the lower frame 15 and the lowest cutting member 12 on the second assembly 6 is greater than the distance from the lower frame 15 and the lowest cutting member 12 on the first assembly 5. In this manner, cutting members 12 from adjacent cutting assemblies 5, 6 do not interfere with one another. Thus, the lowest cutting member 12 from the first assembly 5 is free to rotate without interfering or contacting the lowest cutting member 12 from the second assembly 6. This helps preserve the life of the cutting member 12. Further, it optimizes cutting coverage along the length of the assemblies. This helps ensure that the entire length of the assemblies, in one embodiment, has at least one cutting member 12.

As shown, the cutting block 16 in one embodiment comprises a first cutting assembly 5 and a second cutting assembly 6. In one embodiment the first cutting assembly 5 has a plurality of cutting members 12 spaced apart along its length. The second cutting assembly 6 also has a plurality of cutting members 12 spaced apart along its length. In one embodiment the cutting members 12 on the first cutting assembly 5 are offset from the cutting members 12 on the second cutting assembly 6. As noted, being offset allows cutting members 12 on the first cutting assembly 5 to rotate without interfering with the cutting members 12 on the second cutting assembly 6. Aside from not interfering with one another, having offset cutting members 12 allows additional surface area to be cleared by the cutting members 12. If the cutting members 12 are not offset, then the cutting members from the first and second assembly 5,6 would occupy and clear the same space. In some embodiments this might be preferred. In other embodiments, however, an offset is desirable to increase the real estate occupied by the cutting members 12.

The number of cutting members 12 is for illustrative purposes only and should not be deemed limiting. The specific number of cutting members 12 in an application will depend upon the length of the cutting assemblies 5, 6, the type of cutting member 12 utilized, etc. Further, while one cutting member 12 is discussed, in some embodiments, each location of the cutting member 12 will comprise a plurality of independent cutting member strands.

Having a plurality of cutting members 12 along the length of the cutting assemblies 5,6 provides many advantages. First, rather than a single cutting member 12 which only cuts at one location, having a plurality of spaced-apart cutting members 12 allows the debris to be cut at multiple locations simultaneously. This allows debris to be cut at a much faster pace. Consider a tumbleweed that is several feet tall and several feet wide. This would be difficult to cut with a single strand of cutting member 12. However, because the tumbleweed can be cut in multiple locations simultaneously, the debris can be cut and removed quickly. Thereafter, the cutting block 16 can be moved to the next section of fence, for example.

As depicted, there are two cutting assemblies 5, 6. This embodiment is for illustrative purposes only and should not be deemed limiting. Other embodiments can comprise only one cutting assembly, whereas other embodiments will utilize more than two assemblies.

The assemblies 5, 6 are sandwiched between the top frame 4 the lower frame 15. In one embodiment the assemblies 5, 6 are controlled and rotated via a motor housed in the top frame 4. The motor, in one embodiment, is controlled remotely via the user. In one embodiment a single motor controls and rotates each assembly, whereas in other embodiments, a separate motor rotates each assembly. The motor can be housed in the top frame 4 or otherwise coupled to the assemblies 5,6. Further, while an embodiment utilizing a motor is described, this is for illustrative purposes only and should not be deemed limiting. The assemblies 5,6 can be coupled to any power source which provides for rotation of the assemblies 5,6. They can be connected to a chain or belt which rotates the assemblies 5,6. Thus, the rotational force can originate from a motor, engine, or other power source located on or adjacent to the assemblies 5,6. In other embodiments the power source is located remotely and coupled via a belt, chain, or the like.

As noted, in one embodiment, a motor is housed or stored adjacent to the assemblies 5,6. In cutting, debris and other material can be slung or thrown. Accordingly, in one embodiment the system further comprises a motor housing. This is a housing which at least partially surrounds and protects the motor. The housing can comprise plastic, metal, rubber, and combinations thereof. The housing protects the motor from debris that could otherwise damage the motor.

In one embodiment, prior to deploying, a user will prepare the cutting member. 12. In one embodiment this involves either winding the cutting member 12 into a spool or, if needed, placing an entire spool. As an example, twenty feet of weed eater string will be housed in a spool to be subsequently deployed. The user will prepare each spool for each cutting member 12. The cutting member 12 is then ready to be deployed. In other embodiments, rather than spooling the cutting member 12, the cutting member 12 is cut into the desired lengths and coupled as necessary. In one embodiment the cutting member 12 is cut into 40 inch sections and warmed to straighten and remove the coil.

As the cutting members 12 rotate they cut the brush or debris. A tumbleweed, for instance, can be cut with the cutting members 12. Additionally, the cutting member 12 can draw the tumbleweed by rotating and pulling the tumbleweed into the cutting members 12 where it can be further cut and destroyed. However, in doing so, debris and pieces of the brush can be cut and slung away. This is similar to how a weed eater will throw debris. In many embodiments the quick detach 1 coupler will shield the operator from slung debris that can injure the operator. However, in some embodiments, the cutting block 16 further comprises an external shield. The external shield, in some embodiments, is located upstream of the cutting assemblies 5,6 but downstream of the quick detach 1. In this manner, the external shield protects the operator from flung debris. In one embodiment the external shield is at least partially transparent so the operator can view the cutting assemblies 5,6 and the brush being cleared.

In still other embodiments, the system comprises one or more chutes which collects and directs the cut debris. The chute can direct the cut debris to a discard location. In still other embodiments, the chute is directed to a bag or storage compartment. This will function similar to lawn mowers which have a storage compartment to capture cut grass clippings which can be subsequently deposed or used. The system discussed herein can utilize a chute with or without storage compartments to collect cut debris.

The chute can comprise a single chute or there can be separate chutes for each cutting assembly 5,6. In some embodiments the chutes are standalone, whereas in other embodiments the chutes are utilized with a shied.

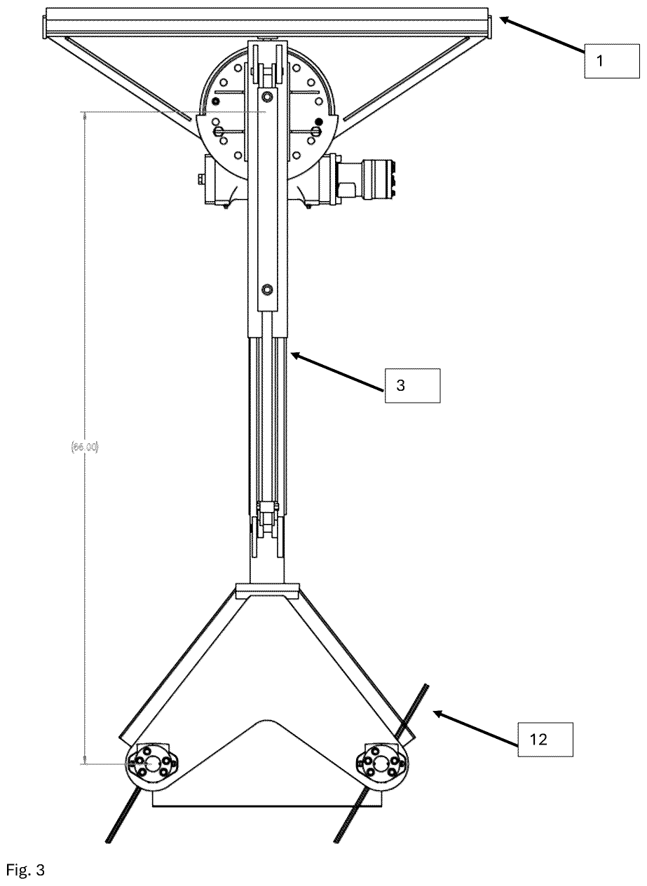

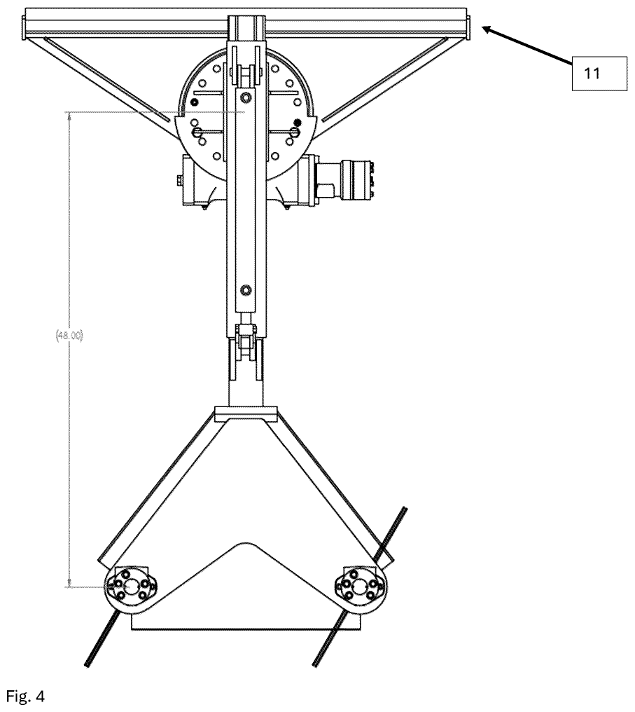

Turning to FIG. 3, FIG. 3 is a top perspective view of the trimmer system in an extended position in one embodiment. As shown, the connector arm 3 is in an extended position. This results in the cutting assemblies 5, 6 being laterally extended relative to the quick detach 1. Thus, the cutting block 16 is moved laterally downstream from the quick detach 1.

The triangular cross-section of the cutting block 16 is visible in this figure. This figure also shows the cutting member 12. As noted, the length and type of the cutting member 12 can be adjusted as necessary.

While a single connector arm 3 is shown, in other embodiments two or more connector arms 3 can be utilized. For example, a first connector arm 3 can be located vertically above a second connector arm 3.

Turning to FIG. 4, FIG. 4 is a top perspective view of the trimmer system in a retracted position in one embodiment. As can be seen, the connector arm 3 is in a retracted position whereby it is moved to a more upstream location. This results in the cutting assemblies 5, 6 being laterally closer to the quick detach 1.

While not shown, in one embodiment there is a joint/pivot between the connector arm 3 and the cutting block 16. This additional joint can provide yet another axis of rotation for the cutting block 16. This additional joint (not shown) can allow the cutting block 16 to be rotated along any desired axis. In some embodiments the cutting block 16 pivots inwardly or outwardly, allowing the cutting block 16 to tilt. As an example, this joint can allow the cutting assemblies 5,6 to move from straight to slanted. Thus, the joint can allow the assemblies 5,6 to tilt. In some embodiments it is desirable that the cutting assemblies 5,6 be straight, whereas in other embodiments an angled approach is better. Such an additional joint provides that ability. Consider a fence which is placed at an angle. The cutting block 16 can be tilted at the joint so that the cutting assemblies 5,6 are parallel to the fence. Further, other axis of rotation can be utilized as well. A pivoting axis similar to the connector 2 can be located at the intersection of the connector arm 3 and the cutting block 16. Even though such is not shown in these figures does not mean other systems cannot utilize such an additional component.

In one embodiment the cutting block 16 is rotatable along two axes. In one embodiment the cutting block 16 is rotatable along three axes.

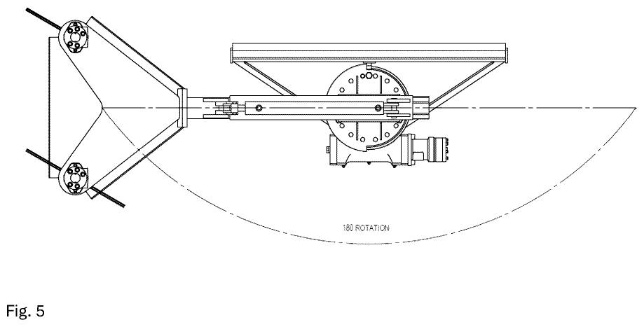

Turning to FIG. 5, FIG. 5 is a top perspective view of the trimmer system in a rotated position in one embodiment. As can be seen, the connector arm 3 is rotated relative to the quick detach 1. In one embodiment, and as depicted, the connector arm 3 can rotate 180 degrees. This provides increased control.

In one embodiment a system for trimming is described. It has a quick detach for coupling. The quick detach can be used to couple to a vehicle. There is a control arm coupled to the quick detach. The control arm is coupled to a cutting block. The cutting block has a vertical support. The vertical support extends between a top frame and a lower frame. One or more cutting assemblies also extend between the top frame and the lower frame.

In one embodiment there is a first cutting assembly and a second cutting assembly. The first and second cutting assemblies each comprise a plurality of cutting members distributed along the length of the cutting assemblies.

To use the system, the quick detach is coupled to a host vehicle, such as a skid steer. The control system can be separate from the controls of the host vehicle, or they can be integrated therein. The controls control the extension of the control arm, the rotation, the tilt, the speed or engagement of the motor, etc.

The controls position the cutting block adjacent to brush or debris to be cut. The cutting assemblies 5,6 are engaged to ensure that the cutting members are rotated. The cutting members are then positioned such that they cut the debris. Once the debris is cut in that section, the vehicle is moved and the cutting block 16 is positioned to cut an additional section. This is repeated until the desired section has been cleared. In one embodiment wherein the fence is barb wire with horizontal posts, one mile of fence line is cleared in about an hour. This would have not been feasible with hand held weed trimmers. As noted, because, in some embodiments, the cutting material 12 is spaced vertically, this allows areas between horizontal rails of a fence to be simultaneously cut. If a single hand held trimmer were to be utilized, each area of the fence between horizontal strands of barb wire would have to be completed separately. Thus, in one embodiment, the system allows simultaneous clearing of debris between horizontal rails or strands of barb wire.

As shown, in one embodiment, the system provides the user with optimized control. The user can control the lateral length by adjusting the connecting arm 3. The user can also rotate the connecting arm 3 relative to the quick detach 1. This allows the user to optimally place and utilize the system. The user can swing the cutting assemblies 5,6 to account for obstacles. The user can swing the cutting assemblies 5,6 out to account for a fence post 11, for example, but swing the cutting assemblies 5,6 back in to get a closer cut.

As noted, the system discussed herein can be used for a variety of purposes. One such purpose is cleaning land adjacent to a fence or other structure such as a row of trees, a ditch, a barn, a body of water, etc. Prior art systems are inadequate to provide close cutting next to fences or other structures. However, there are a variety of factors which make the instant system superior. First, the user has freely rotate and maneuver the cutting assemblies 5, 6 to obtain close proximity when needed. Second, the assemblies 5,6, in some embodiments, have cutting members 12 spaced vertically. This increases the number of cutting members 12. This allows the user to attack the brush at various heights as opposed to attacking the brush with a single string from a single weed eater, for example. Third, by being spaced apart, the user can cut adjacent to a barb wire fence. In some embodiments the cutting members 12 will simply account for the presence of the barb wire and cut around it. Fourth, the user can quickly and efficiently cut and clear around a fence compared to a single weed eater with a single string.

While the invention has been particularly shown and described with reference to a preferred embodiment, it will be understood by those skilled in the art that various changes in form and detail may be made therein without departing from the spirit and scope of the invention.

What is claimed is:

1. A system for trimming, said system comprising:
a quick detach for coupling;
a control arm coupled to said quick detach;
a cutting block comprising:
a vertical support coupled to said control arm;
said vertical support extending between a top frame and a lower frame;
a first assembly extending between said top frame and said lower frame;
a second assembly extending between said top frame and said lower frame;
wherein said first assembly and said second assembly each comprise at least one cutting member.

2. The system of claim 1 wherein said quick detach couples to a host vehicle.

3. The system of claim 1 further comprising a rotary connector on an upstream end of said control arm.

4. The system of claim 3 further comprising a slew drive to manipulate said rotary connector.

5. The system of claim 1 wherein said control arm is laterally moveable between an extended and a retracted position.

6. The system of claim 1 wherein said first assembly comprises a plurality of cutting members spread along a length of said first assembly, and wherein said second assembly comprises a plurality of cutting member spread along a length of said second assembly.

7. The system of claim 6 wherein the plurality of cutting members on said first assembly are offset from the plurality of cutting members on said second assembly.

8. The system of claim 1 wherein said cutting members are c

9. The system of claim 3 wherein said connector arm can pivot 180 degrees relative to said connector.

10. The system of claim 1 wherein said connector arm is hydraulically controlled.

11. The system of claim 1 further comprising a motor coupled to each cutting assembly.

12. The system of claim 1 wherein said cutting block is rotatable along two axes.

13. The system of claim 1 wherein said cutting block is rotatable along three axes.

14. The system of claim 1 further comprising a shield.

15. The system of claim 1 further comprising at least one chute.

16. A method of clearing brush with a trimming system said system comprising:
quick detach for coupling to a host vehicle;
a control arm coupled to said quick detach;
a cutting block comprising:
a vertical support coupled to said control arm;
said vertical support extending between a top frame and a lower frame;
a first assembly extending between said motor frame and said lower frame;
a second assembly extending between said motor frame and said lower frame;
wherein said first assembly and said second assembly each comprise at least one cutting member;
said method comprising:
placing said cutting member adjacent to brush;
rotating said cutting member to clear said brush.

17. The method of claim 14 wherein said placing step comprises placing said cutting member adjacent to a fence.

18. The method of claim 15 wherein said rotating step comprises clearing tumbleweeds stuck along a fence.

19. The method of claim 16 wherein said fence comprises a fence with horizontal rails. and wherein said cutting members fit above and below said horizontal rails.
